(19) United States
(12) Patent Application Publication
(10) Pub. No.: US 2019/0331915 A1
(43) Pub. Date: Oct. 31, 2019

(54) PROJECTION TYPE DISPLAY DEVICE, OPERATING METHOD OF PROJECTION TYPE DISPLAY DEVICE, AND OPERATING PROGRAM OF PROJECTION TYPE DISPLAY DEVICE

(71) Applicant: FUJIFILM Corporation, Tokyo (JP)

(72) Inventor: Hiroyuki OSHIMA, Saitama-shi (JP)

(73) Assignee: FUJIFILM Corporation, Tokyo (JP)

(21) Appl. No.: 16/503,626

(22) Filed: Jul. 5, 2019

Related U.S. Application Data
(63) Continuation of application No. PCT/JP2017/039618, filed on Nov. 1, 2017.

(30) Foreign Application Priority Data
Jan. 10, 2017 (JP) 2017-002138

(51) Int. Cl. G02B 27/01; G02B 27/18; B60K 35/00

(52) U.S. Cl. CPC G02B 27/0149; G02B 27/0101; B60K 2370/1529; B60K 35/00; G02B 27/18

(57) ABSTRACT

Provided are a projection type display device, an operating method of a projection type display device, and an operating program of a projection type display device, capable of supporting mounting of an optimal combiner during work using a working machine to enhance working efficiency. An HUD 100 includes: a combiner support 15 that is provided in an operator cab 5 of a construction machine 1 and supports each of a plurality of combiners 12 having different transmittances to be attachable and detachable therein; a projection display section 50 that projects image light onto the combiner 12 supported by the combiner support 15 to display an image; and a system controller 60 that gives a notification of a combiner 12 to be recommended for work on the basis of a prediction value of a global horizontal irradiance during the work determined by a position of a working site where the work is being performed using the construction machine 1 and a period for which the work is performed.

### CROSS REFERENCE TO RELATED APPLICATION

This is a continuation of International Application No. PCT/JP2017/039618 filed on Nov. 1, 2017, and claims priority from Japanese Patent Application No. 2017-002138 filed on Jan. 10, 2017, the entire disclosures of which are incorporated herein by reference.

### BACKGROUND OF THE INVENTION

### 1. Field of the Invention

The present invention relates to a projection type display device, an operating method of the projection type display device, and a computer readable medium storing an operating program of the projection type display device.

### 2. Description of the Related Art

A vehicle head-up display (HUD) that projects, using a windshield in a vehicle such as an automobile, a train, a ship, a heavy machine, a construction machine, an aircraft, or an agricultural machine, or a combiner disposed in the vicinity of the windshield as a screen, light onto the screen to display an image is known. According to the HUD, it is possible to cause a driver to visually recognize an image based on light projected from the HUD as a real image on a screen or a virtual image in front of the screen.

In the vehicle HUD, in a case where environmental illumination in front of the screen is high, transmitted light that passes through the screen from a front side of the screen and goes toward a driver becomes excessive, so that visibility of a displayed image is lowered. Accordingly, it is effective to increase the brightness of a light source in accordance with the environmental illumination, but there is a limit to improvement of the brightness in view of power consumption and cost, and thus, there is a case where it is not possible to realize sufficient brightness improvement. A method for reducing transmitted light by lowering a transmittance of the screen may be considered, but in a case where the environmental illumination is low, contrarily, the transmitted light becomes insufficient, which affects visibility of forward vision.

JP2004-126450A discloses an HUD that includes a first combiner that is integrally provided in a front windshield of an automobile and a second combiner that is provided to be inserted between the front windshield and a driver, and switches a projection destination of image light between the first combiner and the second combiner that is inserted in front of the first combiner in accordance with peripheral situations or display content. According to this HUD, it is possible to optimize visibility of a displayed image in accordance with peripheral situations.

### SUMMARY OF THE INVENTION

In a case where an HUD is mounted in a construction machine such as a hydraulic excavator, a wheel loader, a bulldozer, or a motor grader, or a working machine such as an agricultural machine such as a tractor, the working machine is in a state where large vibration or shock is applied to a vehicle body, and thus, an electrically driven mechanism disclosed in JP2004-126450A cannot be employed. Accordingly, in the working machine, it is considered that a configuration in which a plurality of combiners having difference transmittances are manually switched is effective.

However, in a case where the combiner is configured to be attached and detached in a manual manner, it is necessary to strongly fix the combiner to the vehicle body so that the combiner is not separated therefrom even though large vibration and shock are applied to the working machine. However, in consideration of the method for strongly fixing the combiner in this way, it is cumbersome to frequently perform the attachment and detachment of the combiner.

Accordingly, in a case where a combiner mounted at the start of work is not optimal for the environmental illumination, it is necessary to continue the work in a state where visibility of a displayed image or visibility of forward vision is not good, which may cause decrease in working efficiency.

The invention has been made in consideration of the above-mentioned problems, and an object of the invention is to provide a projection type display device, an operating method of the projection type display device, and a computer readable medium storing an operating program of the projection type display device, capable of supporting mounting of an optimal combiner during work using a working machine to enhance working efficiency.

According to an aspect of the invention, there is provided a projection type display device mounted in a working machine, comprising: a combiner support that is provided in an operator cab of the working machine and that attachably and detachably supports a combiner among a plurality of combiners having different transmittances; a projection display section that projects image light onto the combiner supported by the combiner support to display an image based on the image light; a working period acquisition section that acquires information on a period during which work is performed by the working machine; a position detection section that detects a position of the working machine; a global horizontal irradiance prediction acquisition section that acquires prediction information of a global horizontal irradiance at the position during the period; and a notification section that gives a notification of a combiner to be recommended for the work among the plurality of combiners on the basis of the prediction information of the global horizontal irradiance.

According to an aspect of the invention, there is provided an operating method of a projection type display device that includes a combiner support that is provided in an operator cab of a working machine and that attachably and detachably supports a combiner among a plurality of combiners having different transmittances, and projects image light onto the combiner supported by the combiner support to display an image based on the image light, the method comprising: a working period acquisition step of acquiring information on a period during which work is performed by the working machine; a position detection step of detecting a position of the working machine; a global horizontal irradiance prediction acquisition step of acquiring prediction information of a global horizontal irradiance at the position during the period; and a notification step of giving a notification of a combiner to be recommended for the work among the plurality of combiners on the basis of the prediction information of the global horizontal irradiance.

According to an aspect of the invention, there is provided a non-transitory computer readable medium storing an operating program of a projection type display device that includes a combiner support that is provided in an operator cab of a working machine and that attachably and detachably supports a combiner among a plurality of combiners having different transmittances, and projects image light onto the combiner supported by the combiner support to display an image based on the image light, the operating program causing a computer to execute: a working period acquisition step of acquiring information on a period during which work is performed by the working machine; a position detection step of detecting a position of the working machine; a global horizontal irradiance prediction acquisition step of acquiring prediction information of a global horizontal irradiance at the position during the period; and a notification step of giving a notification of a combiner to be recommended for the work among the plurality of combiners on the basis of the prediction information of the global horizontal irradiance.

According to the invention, it is possible to provide a projection type display device, an operating method of the projection type display device, and a computer readable medium storing an operating program of the projection type display device, capable of supporting mounting of an optimal combiner during work using a working machine to enhance working efficiency.

### BRIEF DESCRIPTION OF THE DRAWINGS

FIG. 1 is a schematic diagram showing a configuration of a construction machine 1 in which an HUD 100 that is a projection type display device according to an embodiment of the invention is mounted.

FIG. 2 is a schematic diagram showing an example of an internal configuration of an operator cab 5 in the construction machine 1 shown in FIG. 1.

FIG. 3 is a schematic diagram showing a state where a front windshield 11 is seen from a cab seat 6 of the operator cab 5 in the construction machine 1 shown in FIG. 1.

FIG. 4 is a schematic diagram showing an example of an internal configuration of a projection unit 10 shown in FIGS. 1 and 2.

FIG. 5 is a functional block diagram of a system controller 60 shown in FIG. 4.

FIG. 6 is a flowchart for illustrating an operation of the system controller 60 shown in FIG. 4.

FIG. 7 is a diagram showing an example of prediction information of a global horizontal irradiance on an unspecified day in an unspecified area.

FIG. 8 is a flowchart for illustrating a modification example of the operation of the system controller 60 shown in FIG. 4.

FIG. 9 is a schematic diagram showing a configuration in the vicinity of an operator cab of a construction machine 1A that is a modification example of the construction machine 1 shown in FIG. 1.

FIG. 10 is a diagram showing an example of an internal configuration of a projection unit 10A shown in FIG. 9.

FIG. 11 is a functional block diagram of the system controller 60 of the projection unit 10A shown in FIG. 10.

FIG. 12 is a flowchart for illustrating an operation of the system controller 60 shown in FIG. 11.

FIG. 13 is a flowchart for illustrating a modification example of the operation of the system controller 60 shown in FIG. 11.

### DESCRIPTION OF THE PREFERRED EMBODIMENTS

Hereinafter, embodiments of the invention will be described with reference to the accompanying drawings.

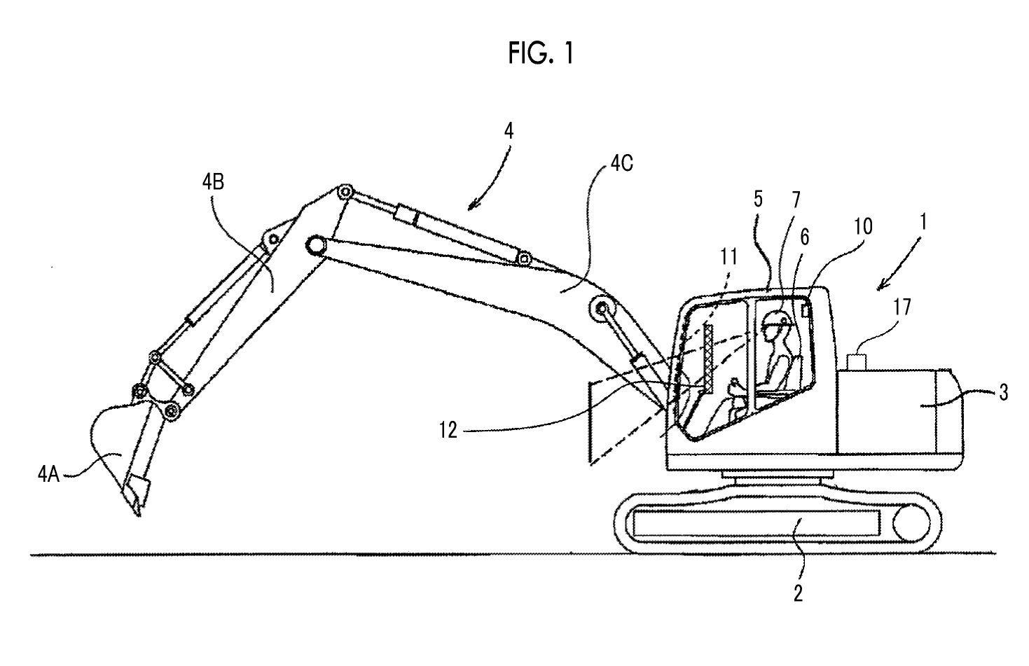

FIG. 1 is a schematic diagram showing a configuration of a construction machine 1 in which an HUD 100 that is a projection type display device according to a first embodiment of the invention is mounted.

The construction machine 1 is a hydraulic excavator, which includes respective parts of a lower traveling body 2, an upper revolving body 3 that is supported to be rotatable on the lower traveling body 2, a front working part 4 that is supported by the upper revolving body 3, and the like. The lower traveling body 2 and the upper revolving body 3 form a main part of the construction machine 1.

The lower traveling body 2 comprises a metallic or rubber crawler for traveling a public road and a workplace.

The upper revolving body 3 comprises an operator cab 5 in which an operating device for operating the front working part 4 and a cab seat 6 on which an operator is seated are provided. A global positioning system (GPS) receiver 17 for detecting a position (latitude and longitude) of the construction machine 1 is provided in the upper revolving body 3.

In the operator cab 5, a front windshield 11 is provided in front of the cab seat 6 where an operator 7 is seated, and a combiner 12 is provided between the front windshield 11 and the cab seat 6.

A projection unit 10 that forms the HUD 100 is provided in the operator cab 5, and causes the operator 7 who sits on the cab seat 6 to visually recognize a virtual image in front of the combiner 12 using image light projected onto the combiner 12.

The front working part 4 comprises an arm 4C that is supported to be movable by the upper revolving body 3 in a gravity direction (a vertical direction in the figure), a boom 4B that is supported by the arm 4C to be rotatable with respect to the arm 4C, and a bucket 4A that is supported by the boom 4B to be rotatable with respect to the boom 4B. The bucket 4A is a part that is directly in contact with a working target such as a ground surface or a discharge, and forms a working tool.

A configuration in which a different working tool such as a steel cutter, a concrete crusher, a gripper, or a percussion type crushing tool, instead of the bucket 4A, is mounted in the boom 4B may be used.

The bucket 4A may be moved in the vertical direction in the figure with respect to the operator cab 5 through the arm 4C and the boom 4B. Further, the bucket 4A is rotatable using a direction (a direction vertical to a sheet plane in the figure) perpendicular to a sight direction of the operator 7 who sits on the cab seat 6 and the gravity direction as an axis. Further, the boom 4B is rotatable using the direction vertical to the sheet plane in the figure as an axis.

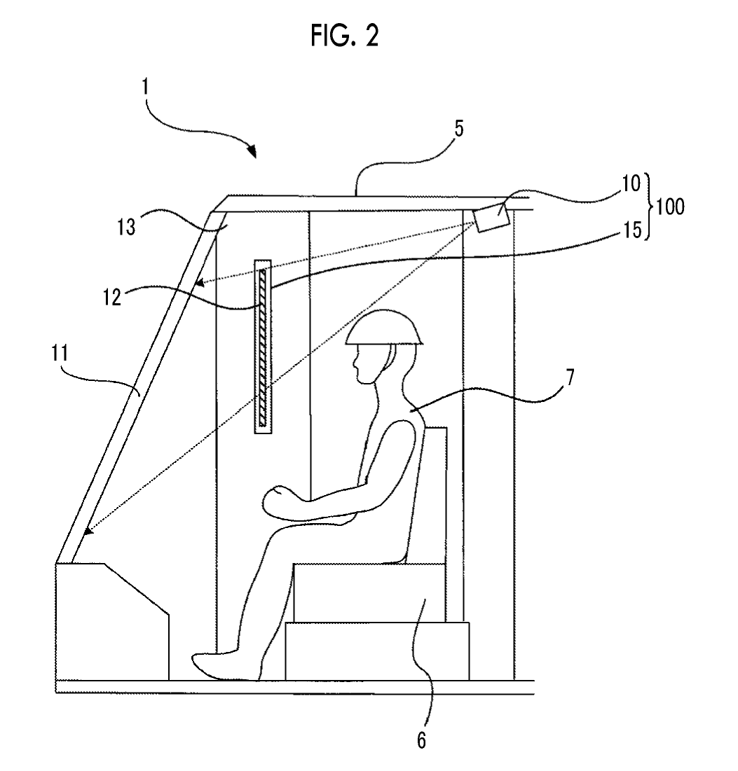

FIG. 2 is a schematic diagram showing an example of an internal configuration of the operator cab 5 in the construction machine 1 shown in FIG. 1.

As shown in FIG. 2, the HUD 100 comprises the projection unit 10 and a combiner support 15 that supports the combiner 12.

The combiner support 15 is fixed to a right side pillar 13 of the operator cab 5. The combiner support 15 is configured so that each of a plurality of combiners 12 having different light transmittances is attachably and detachably provided therein.

Hereinafter, three types of combiners 12, that is, a first combiner, a second combiner having a transmittance that is lower than that of the first combiner, and a third combiner having a transmittance that is lower than that of the second combiner, are attachably and detachably provided in the combiner support 15.

The projection unit 10 is provided on an upper and rear side of the operator 7 in a state where the operator 7 sits on the cab seat 6, and projects image light onto the combiner 12 supported by the combiner support 15.

The operator 7 of the construction machine 1 can view image light that is projected onto the combiner 12 supported by the combiner support 15 and is reflected therefrom to visually recognize information on an icon, characters, or the like for supporting work of the construction machine 1 as a virtual image. Further, the combiner 12 has a function of reflecting the image light projected from the projection unit 10 and transmitting light from the outside (outside world). Accordingly, the operator can visually recognize the virtual image based on the image light projected from the projection unit 10 and an outside scene in an overlapping manner.

In the example shown in FIG. 1, the HUD 100 is mounted in a hydraulic excavator, but the HUD 100 may be similarly mounted in a working machine (for example, a wheel loader, a bulldozer, a motor grader, a forklift, or the like) in which a working tool capable of being operated by an operator is mounted in front of the cab seat 6.

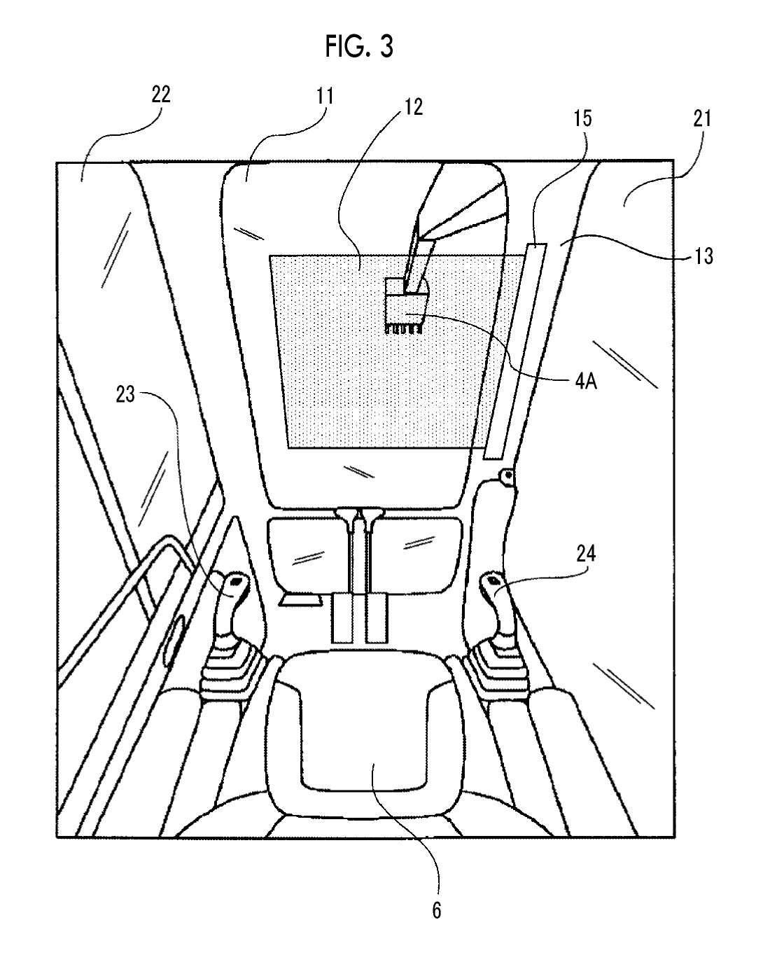

FIG. 3 is a schematic diagram showing a state where the front windshield 11 is seen from the cab seat 6 of the operator cab 5 in the construction machine 1 shown in FIG. 1.

The operator cab 5 is surrounded by the front windshield 11, a right side windshield 21, and a left side windshield 22. The operator cab 5 comprises a left operation lever 23 for operating bending and stretching of the front working part 4 and revolution of the upper revolving body 3, a right operation lever 24 for operating drilling and opening of the bucket 4A of the front working part 4, and the like, around the cab seat 6.

Allocation of operational functions to the left operation lever 23 and the right operation lever 24 is an example, and the invention is not limited thereto. The left operation lever 23 and the right operation lever 24 form an operation member for performing operations of the bucket 4A such as movement of the bucket 4A, drilling using the bucket 4A, and opening of the bucket 4A.

The right side pillar 13 is provided between the front windshield 11 and the right side windshield 21, and the combiner support 15 is fixed to the right side pillar 13.

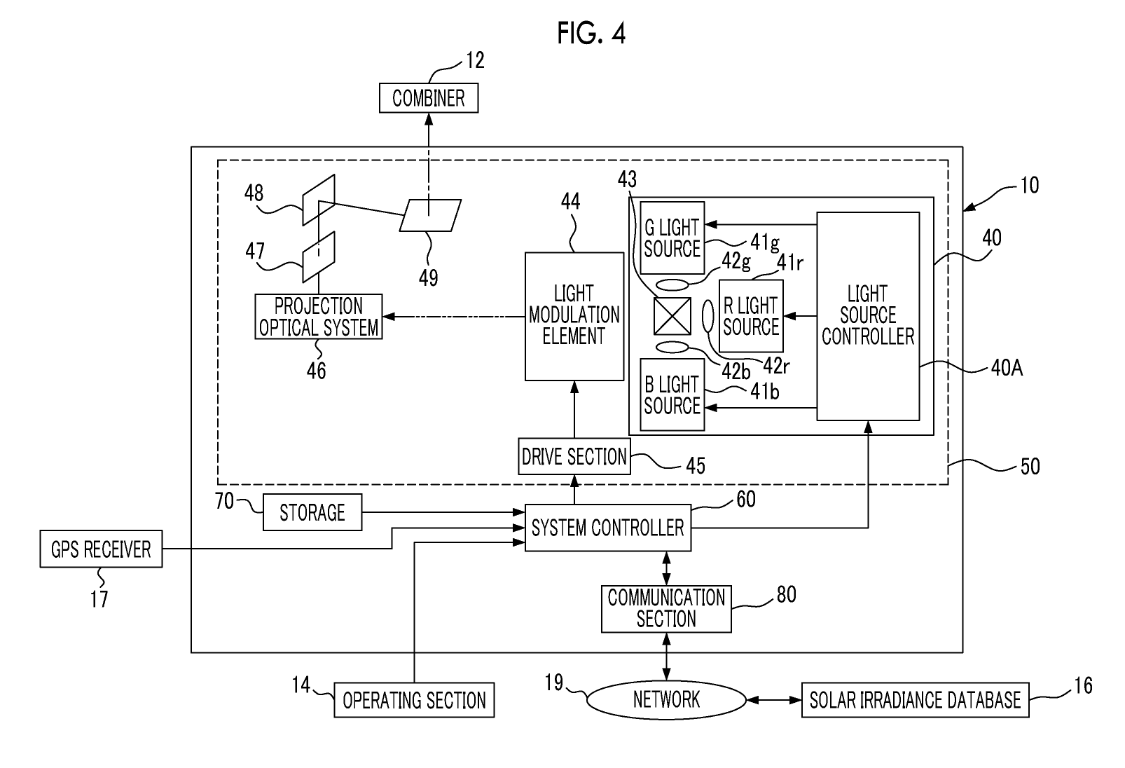

FIG. 4 is a schematic diagram showing an example of an internal configuration of the projection unit 10 shown in FIGS. 1 and 2.

The projection unit 10 comprises a light source unit 40, a light modulation element 44, a drive section 45 that drives the light modulation element 44, a projection optical system 46, a diffuser 47, a reflecting mirror 48, a magnifier 49, a system controller 60 that controls the light source unit 40 and the drive section 45, a storage 70 configured of a storage medium such as a flash memory, and a communication section 80.

The light source unit 40 comprises a light source controller 40A, an R light source 41r that is a red light source that emits red light, a G light source 41g that is a green light source that emits green light, a B light source 41b that is a blue light source that emits blue light, a dichroic prism 43, a collimator lens 42r that is provided between the R light source 41r and the dichroic prism 43, a collimator lens 42g that is provided between the G light source 41g and the dichroic prism 43, and a collimator lens 42b that is provided between the B light source 41b and the dichroic prism 43.

The dichroic prism 43 is an optical member for guiding light emitted from each of the R light source 41r, the G light source 41g, and the B light source 41b to the same optical path. That is, the dichroic prism 43 transmits red light that is collimated by the collimator lens 42r to be output to the light modulation element 44. Further, the dichroic prism 43 reflects green light that is collimated by the collimator lens 42g to be output to the light modulation element 44. In addition, the dichroic prism 43 reflects blue light that is collimated by the collimator lens 42b to be output to the light modulation element 44. An optical member having such a function is not limited to a dichroic prism. For example, a cross dichroic mirror may be used.

The R light source 41r, the G light source 41g, and the B light source 41b may respectively employ a light emitting element such as a laser or a light emitting diode (LED). The R light source 41r, the G light source 41g, and the B light source 41b form light sources of the HUD 100. In this embodiment, the light sources of the projection type display device are configured to include three light sources of the R light source 41r, the G light source 41g, and the B light source 41b, but the number of light sources may be 1, 2, or 4 or more.

The light source controller 40A sets the intensity of light emitted from each of the R light source 41r, the G light source 41g, and the B light source 41b in a predetermined emitted light intensity pattern, and performs a control for sequentially emitting light from the R light source 41r, the G light source 41g, and the B light source 41b according to the emitted light intensity patterns.

The light modulation element 44 spatially modulates light that is emitted from the dichroic prism 43 on the basis of the image information, and emits the spatially modulated light (red color image light, blue color image light, and green color image light) to the projection optical system 46.

The light modulation element 44 may employ, for example, a liquid crystal on silicon (LCOS), a digital micromirror device (DMD), a micro electro mechanical systems (MEMS) element, a liquid crystal display device, or the like.

The drive section 45 drives the light modulation element 44 on the basis of image information input from the system controller 60, and causes light (red color image light, blue color image light, and green color image light) based on the image information to be output to the projection optical system 46.

The light modulation element 44 and the drive section 45 form a light modulator of the HUD 100.

The projection optical system 46 is an optical system that projects light emitted from the light modulation element 44 of the light source unit 40 to the diffuser 47. The optical system is not limited to a lens, and may employ a scanner. For example, light emitted from a scan type scanner may be diffused by the diffuser 47 to become a plane light source.

The reflecting mirror 48 reflects the light diffused by the diffuser 47 toward the magnifier 49.

The magnifier 49 magnifies an image based on the light reflected from the reflecting mirror 48 to be projected onto the combiner 12.

The light source unit 40, the light modulation element 44, the drive section 45, the projection optical system 46, the diffuser 47, the reflecting mirror 48, and the magnifier 49 form a projection display section 50 that spatially modulates light emitted from the R light source 41r, the G light source 41g, and the B light source 41b on the basis of image information input from the system controller 60 and projects image light obtained through the spatial modulation onto the combiner 12 supported by the combiner support 15 to display a virtual image based on the image light.

The system controller 60 controls the light source controller 40A and the drive section 45 so that image light based on image information is emitted to the diffuser 47 through the projection optical system 46.

The diffuser 47, the reflecting mirror 48, and the magnifier 49 shown in FIG. 4 are optically designed so that an image based on image light projected onto the combiner 12 can be visually recognized as a virtual image at a position in front of the combiner 12.

The system controller 60 is configured of a variety of processors as main components, and includes a read only memory (ROM) in which a program for executing the processors is stored, a random access memory (RAM) that is a work memory, and the like.

The variety of processors includes a central processing unit (CPU) that is a general-purpose processor that performs a variety of processes by executing a program, a programmable logic device (PLD) that is a processor capable of changing a circuit configuration after manufacturing, such as a field programmable gate array (FPGA), an exclusive electric circuit that is a processor that has a circuit configuration that is exclusively designed for executing a specific process, such as an application specific integrated circuit (ASIC), or the like.

A structure of the variety of processors is, more specifically, an electric circuit in which circuit elements such as semiconductor devices are combined.

A processor of the system controller 60 may be configured as one processor among a variety of processors, or may be configured as a combination of the same kind or different kinds of two or more processors (for example, a combination of a plurality of FPGAs or a combination of a CPU and an FPGA).

The storage 70 stores a plurality of pieces of work support information, or the like. The work support information refers to information that is displayed in the vicinity of the bucket 4A that is frequently watched by an operator during work and supports efficient progress of the work. The work support information includes characters or an arrow indicating a drilling direction of the bucket 4A, characters or a scale indicating the amount of drilling (OO m), warning information for calling operator's attention, or the like.

The communication section 80 is a communication interface that includes a communication control device, a communication port, and the like and performs communication with another electronic device through a network 19 such as the Internet.

An operating section 14 shown in FIG. 4 is a user interface such as a touch panel that is provided in the operator cab 5 of the construction machine 1. The operator 7 may operate the operating section 14 to input operation plan information or the like to the system controller 60.

The operation plan information refers to, for example, information on a construction location, information on a construction drawing, information on a working period, or the like.

A solar irradiance database 16 shown in FIG. 4 is a computer that manages information of global horizontal irradiances observed all over the country. The solar irradiance database 16 is connected to the network 19, and may be accessed from the HUD 100.

The global horizontal irradiance is a total amount of solar radiation of all the sunlight that the earth surface receives, which is a sum of horizontal components of direct normal irradiance and diffuse horizontal irradiance. The global horizontal irradiance is a solar irradiance per unit time of one second, one minute, or the like, and is expressed in a unit of kilowatts per square meter (kW/m²), watts per square meter (W/m²), or the like.

The solar irradiance database 16 stores prediction information of a global horizontal irradiance (global horizontal irradiance prediction value) per unit period of 30 minutes, 1 hour, three hours, or the like throughout the year all over the country. The global horizontal irradiance prediction value per unit period represents an average value during the unit period. The global horizontal irradiance prediction value is obtained by analyzing a tendency from previously measured values, which is periodically updated. The solar irradiance database 16 replies, in accordance with a request from an accessed electronic device, prediction information of a global horizontal irradiance at a point where the request is performed to the electronic device that is a request source.

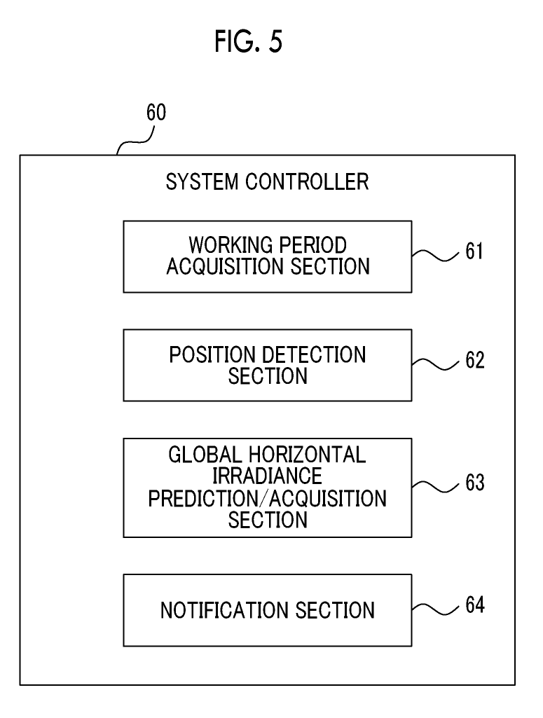

FIG. 5 is a functional block diagram of the system controller 60 shown in FIG. 4.

The system controller 60 functions as a working period acquisition section 61, a position detection section 62, a global horizontal irradiance prediction/acquisition section 63, and a notification section 64 as a processor executes an operating program stored in a ROM.

The working period acquisition section 61 acquires information on a period of work performed by the construction machine 1 on the basis of information input from an operator by operation of the operating section 14.

As the information input from the operator, (A) work starting date and time and work ending date and time, (B) work starting date and time and a period of time for which work is performed, (C) work ending date and time and a period of time for which work is performed, (D) work ending date and time, (E) information indicating details of work, or the like, may be used.

In a case where the information (B) is input, the working period acquisition section 61 calculates the work ending date and time from the work starting date and time and the period of time for which the work is performed, to thereby acquire information on a period of time indicated by the work starting date and time and the work ending date and time.

In a case where the information (C) is input, the working period acquisition section 61 calculates the work starting date and time from the work ending date and time and the period of time for which the work is performed, to thereby acquire information on a period of time indicated by the work starting date and time and the work ending date and time.

In a case where the information (D) is input, the working period acquisition section 61 considers date and time when information from the operator is input as the work starting date and time, to thereby acquire information on a period of time indicated by the work starting date and time and the work ending date and time.

In a case where the information (E) is input, the working period acquisition section 61 estimates time necessary for completing the work on the basis of information indicating details of the work, considers date and time when the information is input as the work starting date and time, and calculates the work ending date and time from the work starting date and time and the estimated time, to thereby acquire information on a period of time indicated by the work starting date and time and the work ending date and time.

The position detection section 62 acquires a signal received by a GPS receiver 17, and detects the position (latitude and longitude) of the construction machine 1 on the basis of the signal.

The global horizontal irradiance prediction/acquisition section 63 acquires prediction information of a global horizontal irradiance during the period of work acquired by the working period acquisition section 61 at the position of the construction machine 1 detected by the position detection section 62, from the solar irradiance database 16.

Information on the point stored in the solar irradiance database 16 is information in each area in a case where all over the country that is an observation target of solar irradiance is divided into multiple areas. Accordingly, the global horizontal irradiance prediction/acquisition section 63 specifies an area including the position detected by the position detection section 62, and acquires prediction information of a global horizontal irradiance corresponding to the area from the solar irradiance database 16.

The notification section 64 gives a notification of a combiner to be recommended for work among the three types of combiners 12 on the basis of the prediction information of the global horizontal irradiance acquired by the global horizontal irradiance prediction/acquisition section 63.

The notification section 64 performs the notification of the recommended combiner using a method for causing a display device (not shown) provided in the operator cab 5 of the construction machine 1 to display a message, or a method for outputting the message through a speaker (not shown) provided in the operator cab 5 of the construction machine 1 in a form of voice, for example.

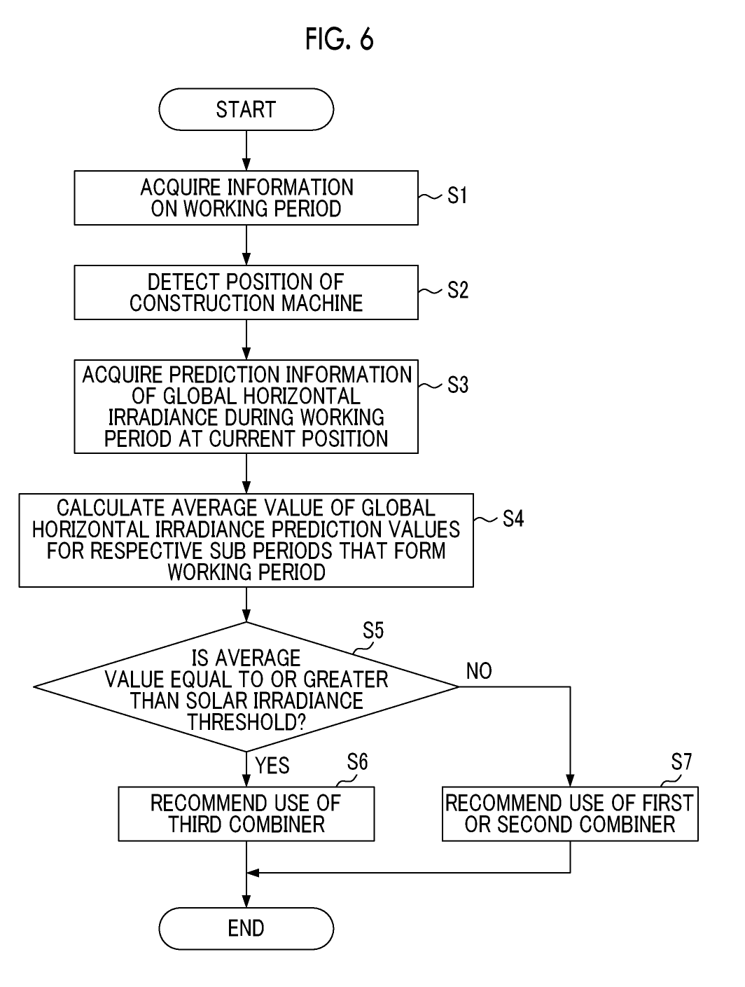

FIG. 6 is a flowchart for illustrating an operation of the system controller 60 shown in FIG. 4.

In a case where the HUD 100 is started, the system controller 60 requests an operator to input any one of the pieces of information (A) to (E) using the display device (not shown) or the speaker (not shown) provided in the operator cab 5. In a case where the operator operates the operating section 14 to input information in accordance with the request, information on a working period is acquired by the working period acquisition section 61 on the basis of the information (step S1), and is temporarily stored in a RAM of the system controller 60.

Then, the position detection section 62 detects the position of the construction machine 1 on the basis of a signal received by the GPS receiver 17 (step S2).

Then, the global horizontal irradiance prediction/acquisition section 63 acquires prediction information of a global horizontal irradiance during the working period acquired in step Si in an area including the position detected step S2, from the solar irradiance database 16 (step S3).

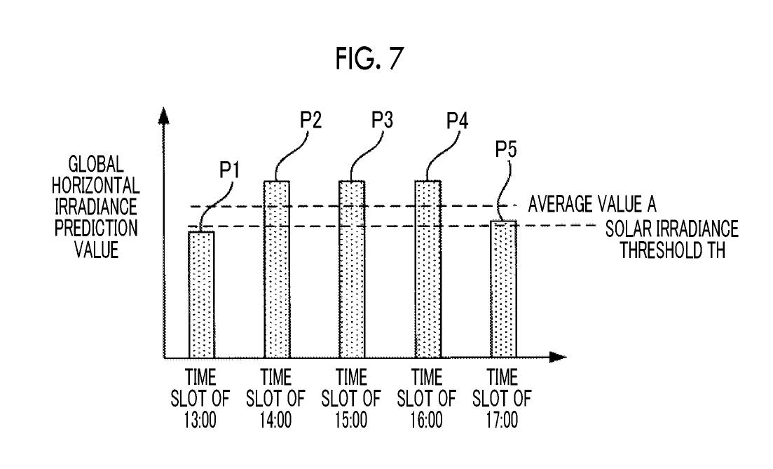

FIG. 7 is a diagram showing an example of prediction information of a global horizontal irradiance on an unspecified day in an unspecified area. In FIG. 7, a longitudinal axis represents a global horizontal irradiance prediction value (an average value an hour), and a lateral axis represents a time slot. Here, a case where a global horizontal irradiance prediction value per hour is stored in the solar irradiance database 16 will be described as an example.

In FIG. 7, a global horizontal irradiance prediction value P1 at a time slot of 13:00 (13:00 to 13:59:59), a global horizontal irradiance prediction value P2 at a time slot of 14:00 (14:00 to 14:59:59), a global horizontal irradiance prediction value P3 at a time slot of 15:00 (15:00 to 15:59:59), a global horizontal irradiance prediction value P4 at a time slot of 16:00 (16:00 to 16:59:59), and a global horizontal irradiance prediction value P5 at a time slot of 17:00 (17:00 to 17:59:59) are shown. Further, in FIG. 7, an average value A of the global horizontal irradiance prediction values P1 to P5 and a solar irradiance threshold TH are shown.

In a case where the working period acquired in step S1 is between 13:30 on Aug. 1, 2016 and 17:30 on Aug. 1, 2016, for example, global horizontal irradiance prediction values (the global horizontal irradiance prediction values P1 to P5 shown in FIG. 7) during respective five sub-periods (a period of time at the time slot of 13:00, a period of time at the time slot of 14:00, a period of time at the time slot of 15:00, a period of time at the time slot of 16:00, a period of time at the time slot of 17:00) obtained by dividing the period of time in an hour unit are acquired in step S3.

After step S3, the notification section 64 gives a notification of a combiner to be recommended for the work among the three types of combiners 12 on the basis of each of the global horizontal irradiance prediction values P1 to P5 during the five sub-periods.

Specifically, first, the notification section 64 calculates the average value A of the global horizontal irradiance prediction values P1 to P5 during the respective five sub-periods (step S4). Further, in a case where the average value A is equal to or greater than the predetermined solar irradiance threshold value TH (YES in step S5), the notification section 64 determines that the global horizontal irradiance is large during the working period, and performs a notification for recommending use of the third combiner having the lowest transmittance (step S6). In a case where the global horizontal irradiance prediction value acquired in step S3 is shown in FIG. 7, since the average value A is equal to or greater than the solar irradiance threshold TH, the third combiner is recommended for use.

On the other hand, in a case where the average value A is smaller than the solar irradiance threshold value TH (NO in step S5), the notification section 64 determines that the global horizontal irradiance is small during the working period, and performs a notification for recommending use of the first combiner or the second combiner having a transmittance higher than that of the third combiner (step S7).

As described above, according to the HUD 100, on the basis of the prediction information of the global horizontal irradiance during the work determined by the position of the working site where the work is performed by the construction machine 1 and the period of time for which the work is performed, the combiner to be recommended for the work is notified to the operator.

For example, in a case where it is predicted that the global horizontal irradiance is small during the working period, the combiner 12 having a high transmittance is recommended for use, and in a case where it is predicted that the global horizontal irradiance is large during the working period, the combiner 12 having a low transmittance is recommended for use. In this way, it is possible to recommend use of a combiner suitable for the brightness of a work environment during an entire working period. Accordingly, the operator can start the work using the recommended combiner, to thereby make it possible to enhance visibility of an image during the work, and to enhance working efficiency.

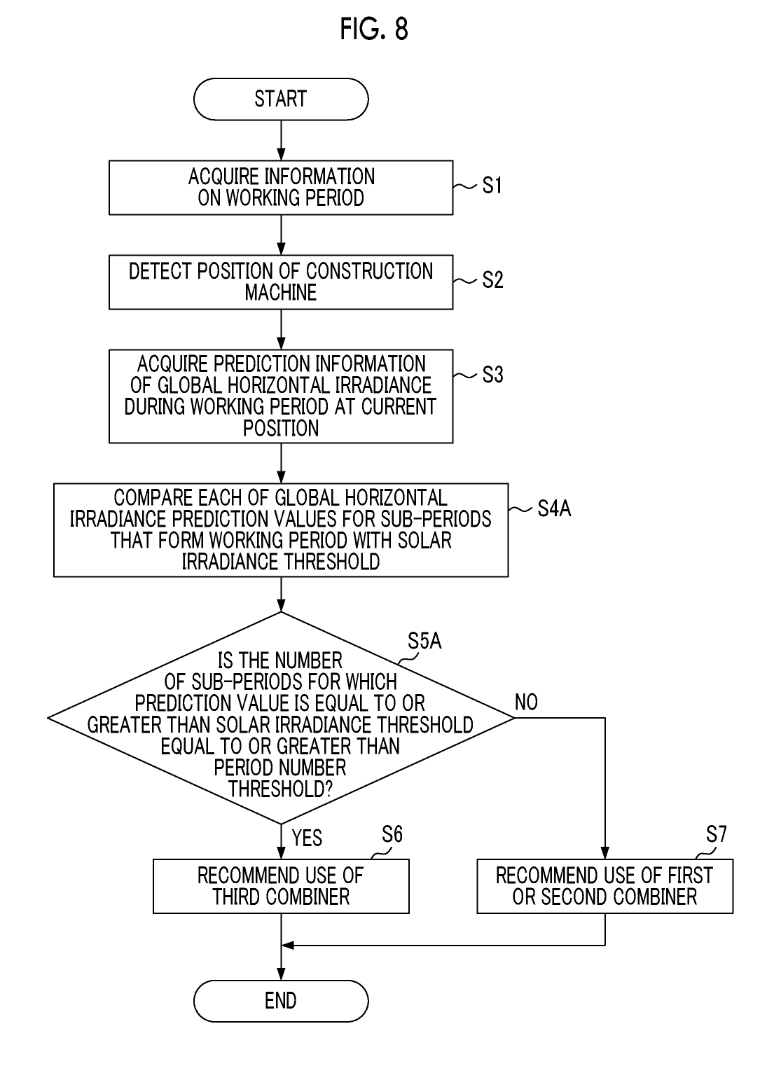

FIG. 8 is a flowchart for illustrating a modification example of the operation of the system controller 60 shown in FIG. 4. In FIG. 8, the same reference numerals are given to the same processes in FIG. 6, and description thereof will not be repeated.

After step S3, the notification section 64 gives a notification of a combiner to be recommended for work among the three types of combiners 12 on the basis of each of the global horizontal irradiance prediction values P1 to P5 during the five sub-periods.

Specifically, first, the notification section 64 compares each of the global horizontal irradiance prediction values P1 to P5 during the five sub-periods with the solar irradiance threshold TH (step S4A). Further, in a case where the number of sub-periods for which the global horizontal irradiance prediction value is equal to or greater than the solar irradiance threshold TH is equal to or greater than a predetermined period number threshold (for example, “3” that is greater than half the number of the sub-periods) (YES in step SSA), the notification section 64 determines that the global horizontal irradiance is large during a working period, and performs a notification for recommending use of the third combiner having the lowest transmittance (step S6). In the example shown in FIG. 7, since the number of sub-periods that is equal to or greater than the solar irradiance threshold TH is 3, the use of the third combiner is recommended.

On the other hand, in a case where the number of periods for which the global horizontal irradiance prediction value is equal to or greater than the solar irradiance threshold TH is smaller than the period number threshold (NO in step SSA), the notification section 64 determines that the global horizontal irradiance is small during the working period, and performs a notification for recommending use of the first or second combiner having a transmittance higher than that of the third combiner (step S7).

As described above, according to the modification example shown in FIG. 8, similarly, it is possible to recommend use of a combiner suitable for the brightness of a work environment during an entire working period to an operator, and to enhance working efficiency.

Hereinbefore, two patterns, that is, a pattern for recommending a first combiner or a second combiner, and a pattern for recommending a third combiner, but three patterns may be used for recommendation.

For example, a first solar irradiance threshold and a second solar irradiance threshold that is smaller than the first solar irradiance threshold are set as the solar irradiance threshold TH used for the determination in step S5. Further, the notification section 64 recommends the third combiner in a case where the average value A is equal to or greater than the first solar irradiance threshold, recommends the second combiner in a case where the average value A is equal to or greater than the second solar irradiance threshold and is smaller than the first solar irradiance threshold, and recommends the first combiner in a case where the average value A is smaller than the second solar irradiance threshold.

Similarly, a first period number threshold and a second period number threshold that is smaller than the first period number threshold are set as the period number threshold used for the determination in step SSA. Further, the notification section 64 recommends the third combiner in a case where the number of sub-periods for which the global horizontal irradiance prediction value is equal to or greater than the solar irradiance threshold TH is equal to or greater than the first period number threshold, recommends the second combiner in a case where the number is equal to or greater than the second period number threshold and is smaller than the first period number threshold, and recommends the first combiner in a case where the number is smaller than the second period number threshold.

With such a configuration, it is possible to support installation of the combiner 12 that is more suitable for a work environment.

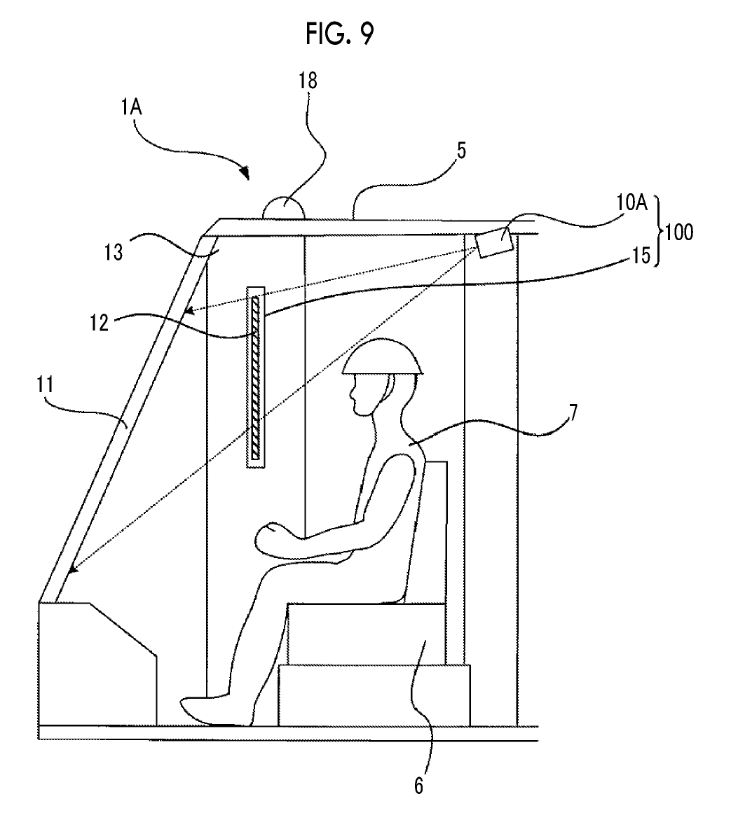

FIG. 9 is a schematic diagram showing a configuration in the vicinity of an operator cab of a construction machine 1A that is a modification example of the construction machine 1 shown in FIG. 1. The construction machine 1A shown in FIG. 9 has the same configuration as that of the construction machine 1 shown in FIG. 1 except that an imaging section 18 is additionally provided on a loop of the operator cab 5 and the projection unit 10 of the HUD 100 is changed to a projection unit 10A.

The imaging section 18 is a camera that includes an imaging element that images a subject and an image processing section that processes a captured image signal output from the imaging element to generate captured image data, and is capable of imaging the periphery of the operator cab 5 of the construction machine 1A over 360 degrees.

As the imaging section 18, a camera that images all directions using a fisheye lens, a camera that images all directions by combining two cameras having an angle of view of about 180 degrees, a camera that images all directions while being rotated by a panning mechanism, or the like may be used. The captured image data generated by the imaging section 18 is transmitted to the projection unit 10A of the HUD 100 in a wired or wireless manner.

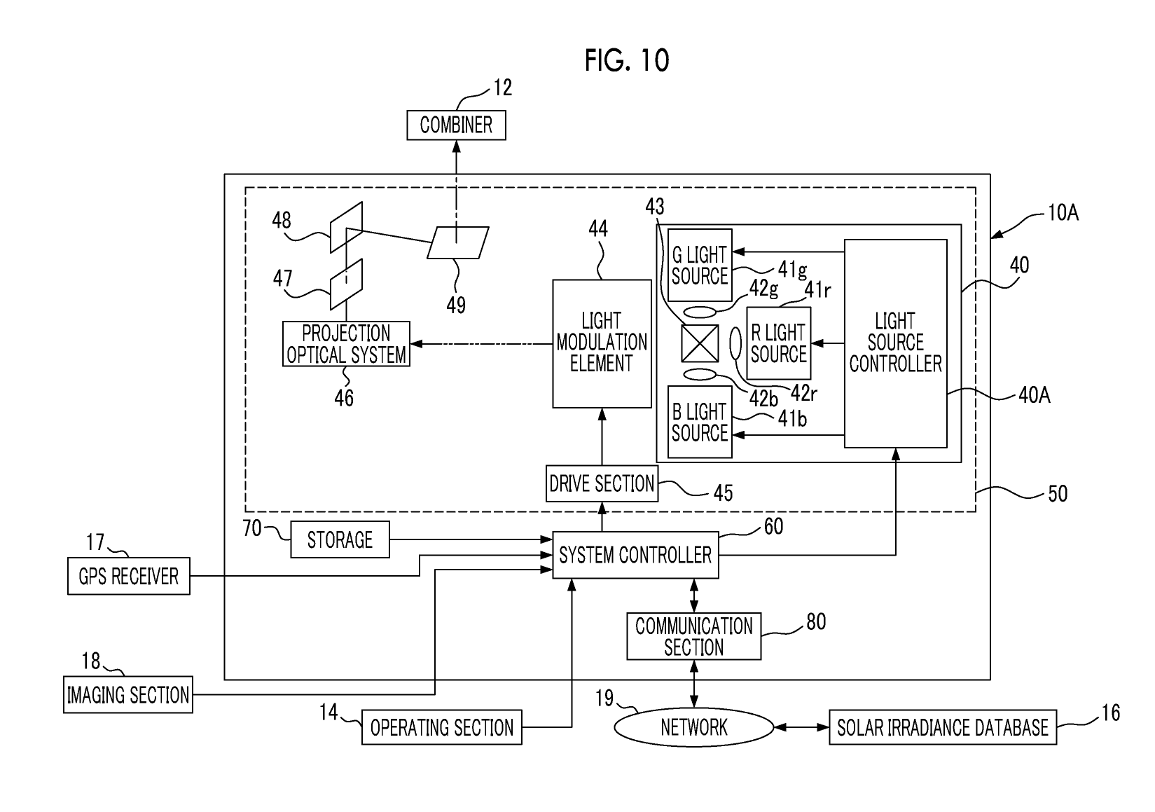

FIG. 10 is a diagram showing an internal configuration example of the projection unit 10A shown in FIG. 9. The projection unit 10A has the same configuration as that of the projection unit 10 shown in FIG. 4 except that captured image data transmitted from the imaging section 18 is input to the system controller 60.

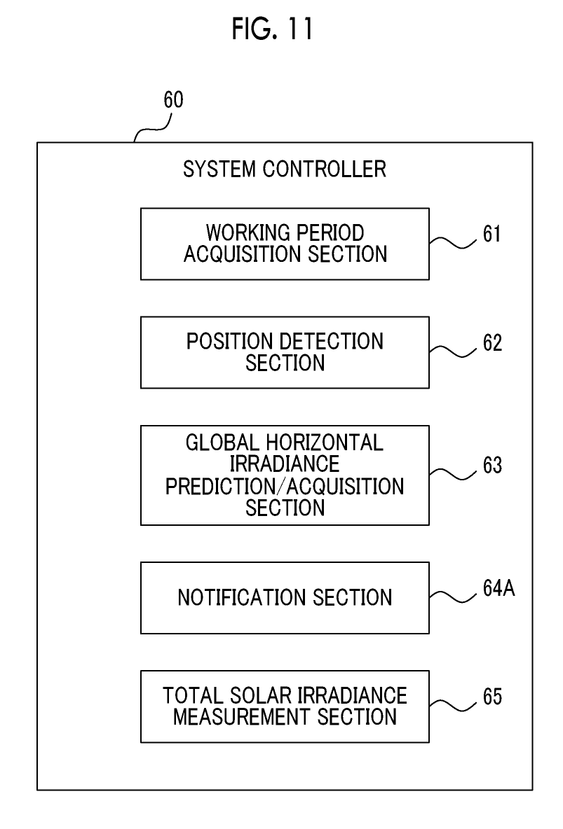

FIG. 11 is a functional block diagram of the system controller 60 of the projection unit 10A shown in FIG. 10.

The functional block diagram shown in FIG. 10 has the same configuration as in FIG. 5 except that a total solar irradiance measurement section 65 is additionally provided and the notification section 64 is changed to a notification section 64A. Each functional block shown in FIG. 10 is formed as a processor of the system controller 60 executes a program including an operating program.

The total solar irradiance measurement section 65 measures a total solar irradiance obtained by adding up a reflection solar irradiance that is a solar irradiance reflected at buildings around a place where the construction machine 1A is present and the ground surface around the place, and the like, and a global horizontal irradiance at the place where the construction machine 1A is present.

First, the total solar irradiance measurement section 65 calculates an average brightness value of all pixels of captured image data input from the imaging section 18. In the ROM of the system controller 60, a relational expression indicating a relationship between an average brightness value of pixels of captured image data acquired in a case where a subject is imaged under an environment of a known solar irradiance and the known solar irradiance is stored in advance. The total solar irradiance measurement section 65 calculates the average brightness value into a solar irradiance according to the relational expression. The calculated solar irradiance becomes a total solar irradiance obtained by adding up a global horizontal irradiance and a reflection solar irradiance at an unspecified point of time at the place where the construction machine 1A is present.

The notification section 64A gives a notification of a combiner to be recommended for work among the plurality of combiners 12 on the basis of the prediction information of the global horizontal irradiance acquired by the global horizontal irradiance prediction/acquisition section 63 and the total solar irradiance measured by the total solar irradiance measurement section 65.

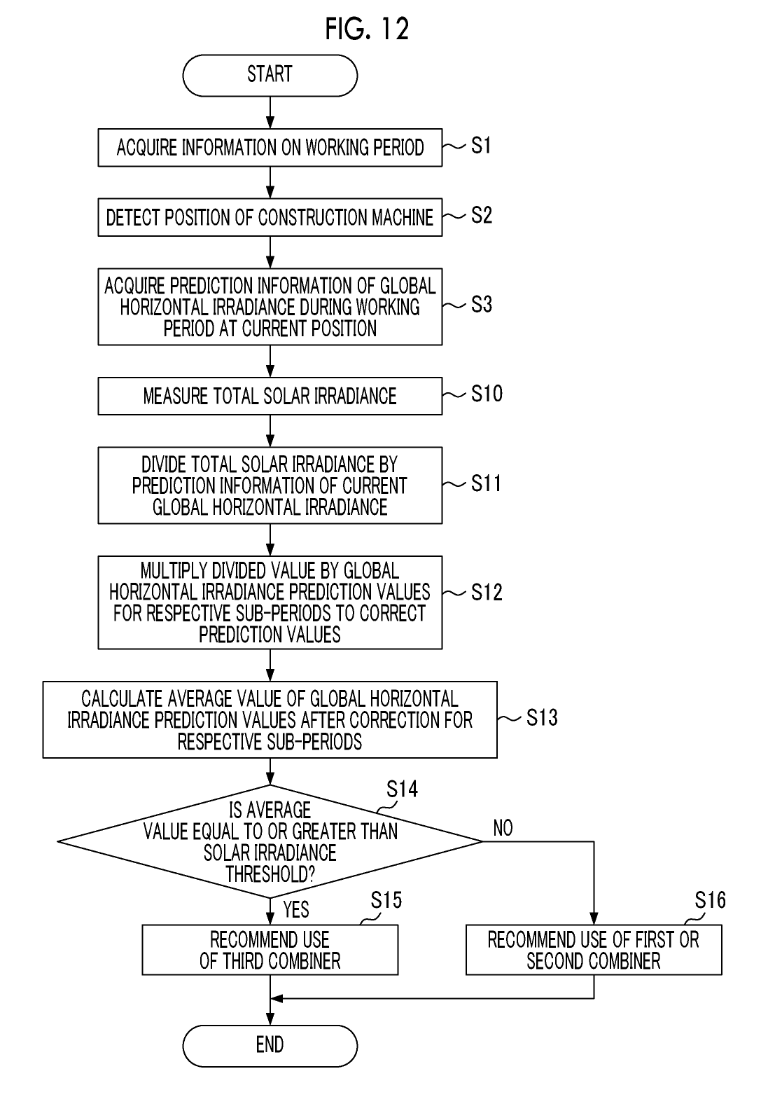

FIG. 12 is a flowchart for illustrating an operation of the system controller 60 shown in FIG. 11. In FIG. 12, the same reference numerals are given to the same processes shown in FIG. 6, and description thereof will not be repeated.

After step S3, the total solar irradiance measurement section 65 controls the imaging section 18 to image the surroundings, calculates an average brightness value of all pixels of captured image data obtained through the imaging, and measures a total solar irradiance from the average brightness value (step S10).

Then, the notification section 64A corrects the global horizontal irradiance prediction values P1 to P5 shown in FIG. 7 obtained in step S3 on the basis of a ratio between the total solar irradiance measured in step S10 and the global horizontal irradiance prediction value at a point of time closest to a point of time when the imaging is performed by the imaging section 18.

Specifically, the notification section 64A divides the total solar irradiance measured in step S10 by the global horizontal irradiance prediction value P1 at the time slot of 13:00 to calculate the ratio (step S11). The global horizontal irradiance prediction value P1 at the time slot of 13:00 is a global horizontal irradiance prediction value during an initial sub-period in the working period acquired in step S1. Since information of the working period is acquired by inputting the information slightly before an operator starts work, the global horizontal irradiance prediction value during the initial sub-period is considered as the global horizontal irradiance prediction value at the point of time closest to the point of time when the imaging is performed.

Subsequently, the notification section 64A multiplies the ratio (the value obtained by the division) by the global horizontal irradiance prediction values P1 to P5, respectively, to correct the global horizontal irradiance prediction values P1 to P5 (step S12).

The global horizontal irradiance prediction value acquired from the solar irradiance database 16 is generated on the basis of information measured under an environment different from a workplace where the construction machine 1A is placed, in which a reflection solar irradiance at the workplace is not considered.

In a case where the reflection solar irradiance is considered, a solar irradiance that reaches the combiner 12 of the construction machine 1A at the workplace becomes larger than the global horizontal irradiance prediction value. On the other hand, for example, in the case of an environment where surroundings of the construction machine 1A do not easily reflect solar radiation (for example, an environment of a lot of black soil or a lot of black buildings), the reflection solar irradiance becomes small, and contrarily, in the case of an environment where surroundings of the construction machine 1A easily reflect solar radiation (for example, an environment of a lot of white ground or a lot of white buildings), the reflection solar irradiance becomes large.

Accordingly, by selecting the combiner 12 on the basis of the corrected global horizontal irradiance prediction values obtained by multiplying the ratio by the global horizontal irradiance prediction values P1 to P5, respectively, it is possible to recommend a more optimal combiner 12.

After step S12, the notification section 64A gives a notification of a combiner to be recommended for the work among the three types of combiners 12 on the basis of the global horizontal irradiance prediction values P1 to P5 after the correction during the five sub-periods.

Specifically, first, the notification section 64A calculates an average value AA of the global horizontal irradiance prediction values P1 to P5 after the correction during the five sub-periods (step S13). Then, the notification section 64A determines that an environment during the working period is a bright environment in a case where the average value AA is equal to or greater than a solar irradiance threshold TH (YES in step S14), and performs a notification for recommending use of the third combiner having the lowest transmittance (step S15).

On the other hand, the notification section 64A determines that an environment during the working period is dark environment in a case where the average value AA is smaller than the solar irradiance threshold TH (NO in step S14), and performs a notification for recommending use of the first combiner or the second combiner having a transmittance higher than that of the third combiner (step S16).

As described above, according to the HUD 100 shown in FIG. 9, it is possible to recommend use of a combiner more suitable for the brightness of a work environment during an entire working period, and to enhance working efficiency.

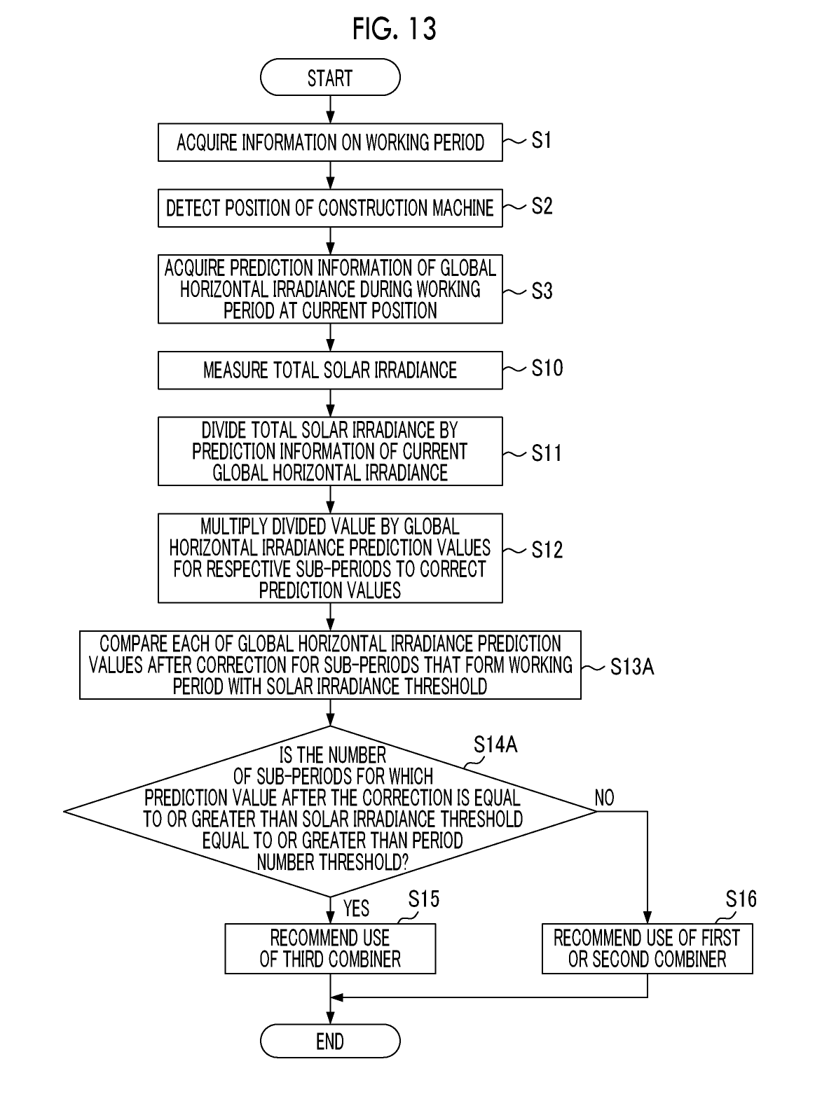

FIG. 13 is a flowchart for illustrating a modification example of the operation of the system controller 60 shown in FIG. 11. In FIG. 13, the same reference numerals are given to the same processes as in FIG. 12, and description thereof will not be repeated.

After step S12, the notification section 64A gives a notification of a combiner to be recommended for work among the three types of combiners 12 on the basis of each of the global horizontal irradiance prediction values P1 to P5 after correction for the five sub-periods.

Specifically, first, the notification section 64A compares each of the global horizontal irradiance prediction values P1 to P5 after correction for the five sub-periods with the solar irradiance threshold TH (step S13A). Further, in a case where the number of the sub-periods for which the global horizontal irradiance prediction value after the correction is equal to or greater than the solar irradiance threshold TH is equal to or greater than a period number threshold (YES in step S14A), the notification section 64A determines that an environment during the working period is a bright environment, and performs a notification for recommending use of the third combiner having the lowest transmittance (step S15).

On the other hand, in a case where the number of periods for which the global horizontal irradiance prediction value after correction is equal to or greater than the solar irradiance threshold TH is smaller than the period number threshold (NO in step S14A), the notification section 64A determines that an environment during the working period is a dark environment, and performs a notification for recommending use of the first or second combiner having a transmittance higher than that of the third combiner (step S16).

As described above, according to the modification example shown in FIG. 13, similarly, it is possible to recommend use of a combiner more suitable for a work environment during an entire working period to an operator, and to enhance working efficiency.

As described above, the following configurations are disclosed in this specification.

(1) There is disclosed a projection type display device mounted in a working machine, comprising: a combiner support that is provided in an operator cab of the working machine and supports each of a plurality of combiners having different transmittances to be attachable and detachable therein; a projection display section that projects image light onto the combiner supported by the combiner support to display an image based on the image light; a working period acquisition section that acquires information on a period of work performed by the working machine; a position detection section that detects a position of the working machine; a global horizontal irradiance prediction/acquisition section that acquires prediction information of a global horizontal irradiance during the period at the position; and a notification section that gives a notification of a combiner to be recommended for the work among the plurality of combiners on the basis of the prediction information of the global horizontal irradiance.

(2) In the projection type display device according to (1), the prediction information of the global horizontal irradiance is formed by a global horizontal irradiance prediction value, in a case where the period is divided into a plurality of sub-periods, for each of the plurality of sub-periods, and the notification section gives a notification of the combiner to be recommended on the basis of the global horizontal irradiance prediction value for each of the plurality of sub-periods.

(3) In the projection type display device according to (2), the notification section gives a notification of, in a case where an average value of the global horizontal irradiance prediction values for the plurality of sub-periods is equal to or greater than a solar irradiance threshold, the combiner having a transmittance that is lower than that of the combiner to be notified in a case where the average value is smaller than the solar irradiance threshold, as the combiner to be recommended for the work.

(4) In the projection type display device according to (2), the notification section gives a notification of, in a case where the number of the sub-periods for which the global horizontal irradiance prediction values are equal to or greater than a solar irradiance threshold among the plurality of sub-periods is equal to or greater than a period number threshold, the combiner having a transmittance that is lower than that of the combiner to be notified in a case where the number is smaller than the period number threshold, as the combiner to be recommended for the work.

(5) In the projection type display device according to (1), the projection type display device further comprises: a total solar irradiance measurement section that measures a total solar irradiance obtained by adding up a reflection solar irradiance and the global horizontal irradiance at the position, and the notification section gives a notification of the combiner to be recommended on the basis of the prediction information of the global horizontal irradiance and the total solar irradiance during the period.

(6) In the projection type display device according to (5), the prediction information of the global horizontal irradiance is formed by the global horizontal irradiance prediction value for each of a plurality of sub-periods in a case where the period is divided into the plurality of sub-periods, and the notification section corrects the global horizontal irradiance prediction value for each of the plurality of sub-periods on the basis of a ratio between the total solar irradiance and the global horizontal irradiance prediction value during an initial sub-period among the plurality of sub-periods, and gives a notification of the combiner to be recommended on the basis of the global horizontal irradiance prediction value after the correction for each of the plurality of sub-periods.

(7) In the projection type display device according to (6), the notification section calculates a division value obtained by dividing the total solar irradiance by the global horizontal irradiance prediction value during the initial sub-period among the plurality of sub-periods as the ratio, and gives a notification of, in a case where an average value of the global horizontal irradiance prediction values after the correction for the plurality of sub-periods is equal to or greater than a solar irradiance threshold, the combiner having a transmittance that is lower than that of the combiner to be notified in a case where the average value is smaller than the solar irradiance threshold, as the combiner to be recommended for the work.

(8) In the projection type display device according to (6), the notification section calculates a division value obtained by dividing the total solar irradiance by the global horizontal irradiance prediction value during the initial sub-period among the plurality of sub-periods as the ratio, and gives a notification of, in a case where the number of the sub-periods for which the global horizontal irradiance prediction values after the correction are equal to or greater than a solar irradiance threshold among the plurality of sub-periods is equal to or greater than a period number threshold, the combiner having a transmittance that is lower than that of the combiner to be notified in a case where the number is smaller than the period number threshold, as the combiner to be recommended for the work.

(9) There is disclosed an operating method of a projection type display device that includes a combiner support that is provided in an operator cab of a working machine and supports each of a plurality of combiners having different transmittances to be attachable and detachable therein, and projects image light onto the combiner supported by the combiner support to display an image based on the image light, the method comprising: a working period acquisition step of acquiring information on a period of work performed by the working machine; a position detection step of detecting a position of the working machine; a global horizontal irradiance prediction/acquisition step of acquiring prediction information of a global horizontal irradiance during the period at the position; and a notification step of giving a notification of a combiner to be recommended for the work among the plurality of combiners on the basis of the prediction information of the global horizontal irradiance.

(10) In the operating method of the projection type display device according to (9), the prediction information of the global horizontal irradiance is formed by a global horizontal irradiance prediction value, in a case where the period is divided into a plurality of sub-periods, for each of the plurality of sub-periods, and in the notification step, the combiner to be recommended is notified on the basis of the global horizontal irradiance prediction value for each of the plurality of sub-periods.

(11) In the operating method of the projection type display device according to (10), in the notification step, in a case where an average value of the global horizontal irradiance prediction values for the plurality of sub-periods is equal to or greater than a solar irradiance threshold, the combiner having a transmittance that is lower than that of the combiner to be notified in a case where the average value is smaller than the solar irradiance threshold is notified, as the combiner to be recommended for the work.

(12) In the operating method of the projection type display device according to (10), in the notification step, in a case where the number of the sub-periods for which the global horizontal irradiance prediction values are equal to or greater than a solar irradiance threshold among the plurality of sub-periods is equal to or greater than a period number threshold, the combiner having a transmittance that is lower than that of the combiner to be notified in a case where the number is smaller than the period number threshold is notified, as the combiner to be recommended for the work.

(13) In the operating method of the projection type display device according to (9), the method further comprises: a total solar irradiance measurement step of measuring a total solar irradiance obtained by adding up a reflection solar irradiance and the global horizontal irradiance at the position, and in the notification step, the combiner to be recommended is notified on the basis of the prediction information of the global horizontal irradiance and the total solar irradiance during the period.

(14) In the operating method of the projection type display device according to (13), the prediction information of the global horizontal irradiance is formed by the global horizontal irradiance prediction value for each of a plurality of sub-periods in a case where the period is divided into the plurality of sub-periods, and in the notification step, the global horizontal irradiance prediction value for each of the plurality of sub-periods is corrected on the basis of a ratio between the total solar irradiance and the global horizontal irradiance prediction value during an initial sub-period among the plurality of sub-periods, and the combiner to be recommended is notified on the basis of the global horizontal irradiance prediction value after the correction for each of the plurality of sub-periods.

(15) In the operating method of the projection type display device according to (14), in the notification step, a division value obtained by dividing the total solar irradiance by the global horizontal irradiance prediction value during the initial sub-period among the plurality of sub-periods is calculated as the ratio, and in a case where an average value of the global horizontal irradiance prediction values after the correction for the plurality of sub-periods is equal to or greater than a solar irradiance threshold, the combiner having a transmittance that is lower than that of the combiner to be notified in a case where the average value is smaller than the solar irradiance threshold is notified, as the combiner to be recommended for the work.

(16) In the operating method of the projection type display device according to (14), in the notification step, a division value obtained by dividing the total solar irradiance by the global horizontal irradiance prediction value during the initial sub-period among the plurality of sub-periods is calculated as the ratio, and in a case where the number of the sub-periods for which the global horizontal irradiance prediction values after the correction are equal to or greater than a solar irradiance threshold among the plurality of sub-periods is equal to or greater than a period number threshold, the combiner having a transmittance that is lower than that of the combiner to be notified in a case where the number is smaller than the period number threshold is notified, as the combiner to be recommended for the work.

(17) There is disclosed an operating program of a projection type display device that includes a combiner support that is provided in an operator cab of a working machine and supports each of a plurality of combiners having different transmittances to be attachable and detachable therein, and projects image light onto the combiner supported by the combiner support to display an image based on the image light, the program causing a computer to execute: a working period acquisition step of acquiring information on a period of work performed by the working machine; a position detection step of detecting a position of the working machine; a global horizontal irradiance prediction/acquisition step of acquiring prediction information of a global horizontal irradiance during the period at the position; and a notification step of giving a notification of a combiner to be recommended for the work among the plurality of combiners on the basis of the prediction information of the global horizontal irradiance.

According to the invention, it is possible to provide a projection type display device, an operating method of the projection type display device, and an operating program of the projection type display device, capable of supporting mounting of an optimal combiner during work using a working machine to enhance working efficiency.

As described above, the invention has been described with reference to specific embodiments, but the invention is not limited to the embodiments, and a variety of modifications may be made in a range without departing from the technical concept of the invention.

This application is based on Japanese patent application (Japanese Patent Application No. 2017-002138), filed on Jan. 10, 2017, the disclosure of which is incorporated herein by reference.

### EXPLANATION OF REFERENCES

100: HUD

1, 1A: construction machine

2: lower traveling body

3: upper revolving body

4: front working part

4A: bucket

4B: boom

4C: arm

5: operator cab

6: cab seat

7: operator

11: front windshield

12: combiner

13: right side pillar

14: operating section

15: combiner support

16: solar irradiance database

17: GPS receiver

18: imaging section

19: network

10, 10A: projection unit

21: right side windshield

22: left side windshield

23: left operation lever

24: right operation lever

40: light source unit

40A: light source controller

41r: R light source

41g: G light source

41b: B light source

42r, 42g, 42b: collimator lens

43: dichroic prism

44: light modulation element

45: drive section

46: projection optical system

47: diffuser

48: reflecting mirror

49: magnifier

50: projection display section

60: system controller

61: working period acquisition section

62: position detection section

63: global horizontal irradiance prediction/acquisition section

64, 64A: notification section

65: total solar irradiance measurement section

70: storage

80: communication section

P1 to P5: global horizontal irradiance prediction value

What is claimed is:

1. A projection type display device mounted in a working machine, comprising:
a combiner support that is provided in an operator cab of the working machine and that attachably and detachably supports a combiner among a plurality of combiners having different transmittances;
a projection display section that projects image light onto the combiner supported by the combiner support to display an image based on the image light;
a working period acquisition section that acquires information on a period during which work is performed by the working machine;
a position detection section that detects a position of the working machine;
a global horizontal irradiance prediction acquisition section that acquires prediction information of a global horizontal irradiance at the position during the period; and
a notification section that gives a notification of a combiner to be recommended for the work among the plurality of combiners on the basis of the prediction information of the global horizontal irradiance.

2. The projection type display device according to claim 1,
wherein, in a case where the period is divided into a plurality of sub-periods, the prediction information of the global horizontal irradiance includes a global horizontal irradiance prediction value for each of the plurality of sub-periods, and
wherein the notification section gives a notification of the combiner to be recommended on the basis of the global horizontal irradiance prediction value for each of the plurality of sub-periods.

3. The projection type display device according to claim 2,
wherein the notification section gives a notification of, in a case where an average value of the global horizontal irradiance prediction values for the plurality of sub-periods is equal to or greater than a solar irradiance threshold, a combiner having a transmittance that is lower than a transmittance of a combiner to be notified in a case where the average value is smaller than the solar irradiance threshold, as the combiner to be recommended for the work.

4. The projection type display device according to claim 2,
wherein the notification section gives a notification of, in a case where a number of sub-periods for which the global horizontal irradiance prediction values are equal to or greater than a solar irradiance threshold among the plurality of sub-periods is equal to or greater than a period number threshold, a combiner having a transmittance that is lower than a transmittance of a combiner to be notified in a case where the number of the sub-periods for which the global horizontal irradiance prediction values are equal to or greater than the solar irradiance threshold is smaller than the period number threshold, as the combiner to be recommended for the work.

5. The projection type display device according to claim 1, further comprising:
a total solar irradiance measurement section that measures a total solar irradiance obtained by adding up a reflection solar irradiance and the global horizontal irradiance at the position,
wherein the notification section gives a notification of the combiner to be recommended on the basis of the prediction information of the global horizontal irradiance and the total solar irradiance during the period.

6. The projection type display device according to claim 5,
Wherein, in a case where the period is divided into a plurality of sub-periods, the prediction information of the global horizontal irradiance includes a global horizontal irradiance prediction value for each of the plurality of sub-periods, and
wherein the notification section corrects the global horizontal irradiance prediction value for each of the plurality of sub-periods on the basis of a ratio between the total solar irradiance and a global horizontal irradiance prediction value during an initial sub-period among the plurality of sub-periods, and gives a notification of the combiner to be recommended on the basis of the global horizontal irradiance prediction value corrected for each of the plurality of sub-periods.

7. The projection type display device according to claim 6,
wherein the notification section calculates a division value obtained by dividing the total solar irradiance by the global horizontal irradiance prediction value during the initial sub-period among the plurality of sub-periods as the ratio, and gives a notification of, in a case where an average value of the global horizontal irradiance prediction values after the correction for the plurality of sub-periods is equal to or greater than a solar irradiance threshold, a combiner having a transmittance that is lower than a transmittance of a combiner to be notified in a case where the average value is smaller than the solar irradiance threshold, as the combiner to be recommended for the work.

8. The projection type display device according to claim 6,
wherein the notification section calculates a division value obtained by dividing the total solar irradiance by the global horizontal irradiance prediction value during the initial sub-period among the plurality of sub-periods as the ratio, and gives a notification of, in a case where a number of sub-periods for which the global horizontal irradiance prediction values corrected are equal to or greater than a solar irradiance threshold among the plurality of sub-periods is equal to or greater than a period number threshold, a combiner having a transmittance that is lower than a transmittance of a combiner to be notified in a case where the number of the sub-periods for which the global horizontal irradiance prediction values are equal to or greater than the solar irradiance threshold is smaller than the period number threshold, as the combiner to be recommended for the work.

9. An operating method of a projection type display device that includes a combiner support that is provided in an operator cab of a working machine and that attachably and detachably supports a combiner among a plurality of combiners having different transmittances, and projects image light onto the combiner supported by the combiner support to display an image based on the image light, the method comprising:
a working period acquisition step of acquiring information on a period during which work is performed by the working machine;
a position detection step of detecting a position of the working machine;
a global horizontal irradiance prediction acquisition step of acquiring prediction information of a global horizontal irradiance at the position during the period; and
a notification step of giving a notification of a combiner to be recommended for the work among the plurality of combiners on the basis of the prediction information of the global horizontal irradiance.

10. The operating method of the projection type display device according to claim 9,
wherein, in a case where the period is divided into a plurality of sub-periods, the prediction information of the global horizontal irradiance includes a global horizontal irradiance prediction value for each of the plurality of sub-periods, and
wherein in the notification step, the combiner to be recommended is notified on the basis of the global horizontal irradiance prediction value for each of the plurality of sub-periods.

11. The operating method of the projection type display device according to claim 10,
wherein in the notification step, in a case where an average value of the global horizontal irradiance prediction values for the plurality of sub-periods is equal to or greater than a solar irradiance threshold, a combiner having a transmittance that is lower than a transmittance of a combiner to be notified in a case where the average value is smaller than the solar irradiance threshold is notified, as the combiner to be recommended for the work.

12. The operating method of the projection type display device according to claim 10,
wherein in the notification step, in a case where a number of sub-periods for which the global horizontal irradiance prediction values are equal to or greater than a solar irradiance threshold among the plurality of sub-periods is equal to or greater than a period number threshold, a combiner having a transmittance that is lower than a transmittance of a combiner to be notified in a case where the number of the sub-periods for which the global horizontal irradiance prediction values are equal to or greater than the solar irradiance threshold is smaller than the period number threshold is notified, as the combiner to be recommended for the work.

13. The operating method of the projection type display device according to claim 9, further comprising:
a total solar irradiance measurement step of measuring a total solar irradiance obtained by adding up a reflection solar irradiance and the global horizontal irradiance at the position,
wherein in the notification step, the combiner to be recommended is notified on the basis of the prediction information of the global horizontal irradiance and the total solar irradiance during the period.

14. The operating method of the projection type display device according to claim 13,
wherein, in a case where the period is divided into a plurality of sub-periods, the prediction information of the global horizontal irradiance includes the global horizontal irradiance prediction value for each of the plurality of sub-periods, and
wherein in the notification step, the global horizontal irradiance prediction value for each of the plurality of sub-periods is corrected on the basis of a ratio between the total solar irradiance and a global horizontal irradiance prediction value during an initial sub-period among the plurality of sub-periods, and the combiner to be recommended is notified on the basis of the global horizontal irradiance prediction value corrected for each of the plurality of sub-periods.

15. The operating method of the projection type display device according to claim 14,
wherein in the notification step, a division value obtained by dividing the total solar irradiance by the global horizontal irradiance prediction value during the initial sub-period among the plurality of sub-periods is calculated as the ratio, and in a case where an average value of the global horizontal irradiance prediction values after the correction for the plurality of sub-periods is equal to or greater than a solar irradiance threshold, a combiner having a transmittance that is lower than a transmittance of a combiner to be notified in a case where the average value is smaller than the solar irradiance threshold is notified, as the combiner to be recommended for the work.

16. The operating method of the projection type display device according to claim 14,
wherein in the notification step, a division value obtained by dividing the total solar irradiance by the global horizontal irradiance prediction value during the initial sub-period among the plurality of sub-periods is calculated as the ratio, and in a case where a number of the sub-periods for which the global horizontal irradiance prediction values corrected are equal to or greater than a solar irradiance threshold among the plurality of sub-periods is equal to or greater than a period number threshold, a combiner having a transmittance that is lower than a transmittance of a combiner to be notified in a case where the number of the sub-periods for which the global horizontal irradiance prediction values are equal to or greater than the solar irradiance threshold is smaller than the period number threshold is notified, as the combiner to be recommended for the work.

17. A non-transitory computer readable medium storing an operating program of a projection type display device that includes a combiner support that is provided in an operator cab of a working machine and that attachably and detachably supports a combiner among a plurality of combiners having different transmittances, and projects image light onto the combiner supported by the combiner support to display an image based on the image light, the operating program causing a computer to execute:
a working period acquisition step of acquiring information on a period during which work is performed by the working machine;
a position detection step of detecting a position of the working machine;
a global horizontal irradiance prediction acquisition step of acquiring prediction information of a global horizontal irradiance at the position during the period; and
a notification step of giving a notification of a combiner to be recommended for the work among the plurality of combiners on the basis of the prediction information of the global horizontal irradiance.
